(19) United States
(12) Patent Application Publication
(10) Pub. No.: US 2026/0162093 A1
(43) Pub. Date: Jun. 11, 2026

(54) MULTI-ACCOUNT PAYMENT CARD

(71) Applicants: American Express Travel Related Services Company, Inc., New York, NY (US); American Express Services Europe Limited, London (GB)

(72) Inventors: Ryan Nicholas Baumann, Phoenix, AZ (US); Tonia Bui, Sacramento, CA (US); Fernando Campos Costa, Croydon (GB); Julia Genina, New York, NY (US); Jonathan Ward Lupton, Littlehampton (GB)

(21) Appl. No.: 18/975,089

(22) Filed: Dec. 10, 2024

(51) Int. Cl. G06Q 20/22; G06Q 20/02

(52) U.S. Cl. CPC G06Q 20/29; G06Q 20/027

(57) ABSTRACT

Disclosed are various embodiments for a multi-account payment card. A payment proxy service can receive a transaction authorization request from an acquirer system, the transaction authorization request comprising a payment token, wherein the payment token simultaneously represents both a first payment account identifier for a first payment account associated with a first payment processing system and a second payment account identifier for a second payment account associated with a second payment processing system. The payment proxy service can then select the first payment processing system or the second payment processing service as a selected payment processing system based at least in part on an indicator associated with the transaction authorization request. Next, the payment processing service can forward the transaction authorization request to the selected payment processing system.

### BACKGROUND

Individuals often have multiple payment accounts (e.g., checking accounts, savings accounts, credit card accounts, etc.) which can be used to make payments. These payment accounts can be located at the same institution or at different institutions. For example, a person could have a checking account with one bank and a credit card account with another bank. As another example, a person could have a checking account and a credit card account with the same bank.

Banks often issue a payment instrument per payment account to allow payments to be made. For example, a bank could issue a credit card to allow payments to be made using a credit card account. As another example, a bank could issue a debit card that allows payments to be made using a checking account. In some instances, a payment card could allow for payments with a single account to be made using different payment rails. For example, a debit card could be issued that allows a user to make a payment using the VISA® or MASTERCARD® credit card network or an Electronic Funds Transfer at Point of Sale (EFTPOS) network (e.g., PULSE®, NYCE®, MAC®, TYME®, SHAZAM®, STAR®, etc.). In this example, the payment would be deducted from the checking account backing the debit card regardless of the payment network or rail used for the transaction.

In some instances, banks could even issue payment cards that allow a user to make a purchase using one of multiple linked accounts. For example, a bank could issue the same account number to multiple linked accounts (e.g., the same account number for checking account and for a credit card account). This would allow a user to use the same payment card to make withdrawals from an ATM, make an EFTPOS payment at a payment terminal that accepts debit cards, or make a credit card payment at a payment terminal that accepts credit cards. However, these solutions require extensive administrative overhead coordinating the use of the same account number for multiple different types of accounts. For example, if a user's credit card number is stolen from a merchant, the shared account number for all linked accounts (checking account, credit card account, etc.) would need to be changed. There is also additional administrative overhead in coordinating the creation of accounts with the same account number as the information technology (IT) systems employed for different types of payment accounts may operate by different departments or even different entities (e.g., different banks).

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a drawing depicting an example of an EMV chip according to various embodiments of the present disclosure.

FIG. 2 is a drawing of a payment environment according to various embodiments of the present disclosure.

FIG. 3 is a sequence diagram depicting the operations of and interactions between the various components of the payment environment of FIG. 2 according to various embodiments of the present disclosure.

FIG. 4 is a depiction of a PoS terminal in the payment environment of FIG. 2 according to various embodiments of the present disclosure.

FIG. 5 is a sequence diagram depicting the operations of and interactions between the various components of the payment environment of FIG. 2 according to various embodiments of the present disclosure.

FIGS. 6A-6D are user interface diagrams depicting an example of a user experience in relation to the sequence diagram of FIG. 5 according to various embodiments of the present disclosure.

### DETAILED DESCRIPTION

Disclosed are various approaches for issuing payment cards that allow for a user to use multiple payment funding sources, and therefore multiple payment rails, with the same payment card and the same payment account number. As the number of payment cards issues to users proliferates, users often find themselves with multiple payment cards available to use complete a transaction, one for each source of funds available to the user (e.g., separate debit cards for each checking account and separate credit cards for each credit card account).

Moreover, payment cards are often required to have a single account number associated with the payment card. For example, separate debit cards might be issued for separate bank accounts, each with their own account number. Likewise, separate credit cards could be issues for separate credit card accounts. Each of these separate cards would have its own, unique account number associated with it, often corresponding to the account number of the underlying funding source (e.g., checking account, credit card account, etc.).

Various embodiments of the present disclosure simplify the payment process by allowing a user to carry and use a single card, with a single account number, for payments that are backed by multiple funding sources and for payments that can be made using multiple payment rails. For example, a single card could be used to make payments for small purchases using a checking account as a funding source (e.g., like a bank card or debit card) and make payments for large purchases using a line of credit as a funding source (e.g., like a credit card). The user could indicate, at the time of sale, which payment source to use, and the transaction authorization request could be routed to a payment proxy service 219, which can evaluate the transaction authorization request and route it to the appropriate payment processing service.

In the following discussion, a general description of the system and its components is provided, followed by a discussion of the operation of the same. Although the following discussion provides illustrative examples of the operation of various components of the present disclosure, the use of the following illustrative examples does not exclude other implementations that are consistent with the principals disclosed by the following illustrative examples.

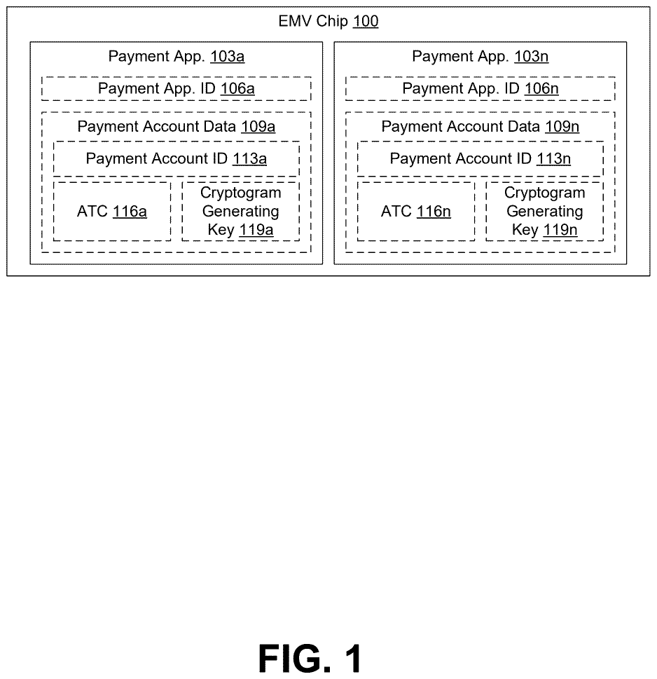

FIG. 1 depicts a schematic block diagram of a EUROPAY®, MASTERCARD®, and VISA® (EMV) chip 100 according to various embodiments of the present disclosure. An EMV chip 100 can be included in a payment card (e.g., a debit card, credit card, charge card, etc.) to provide cryptographic authentication and verification of transactions (e.g., purchases) made using the payment card. For example, the EMV chip 100 included in a payment card could be used to authenticate a transaction to prove that the payment card is an authorized or valid payment card and has neither expired nor been counterfeited. Accordingly, an EMV chip 100 can contain one or more payment applications 103, depicted as payment applications 103a-n, as well as other data. An EMV chip 100 could contain multiple payment applications, for example, to allow for a single payment card to support or facilitate payments made across different payment rails (e.g., debit card and credit card rails); to support or facilitate payments made across the same rail using different payment accounts (e.g., a payments made over the same credit card rail using checking account or credit accounts as the source of funds); or to support or facilitate payments made using different accounts with different financial institutions (e.g., one account for international transactions and another account for domestic transactions).

Each payment application 103 can be executed to confirm or authorize a transaction made by a respective payment card. Individual payment applications 103 can be provisioned on the EMV chip 100 by issuers (e.g., a financial institution could provision an EMV chip 100 with separate payment applications 103 for a debit card rail and a credit card rail). Accordingly, each payment application 103 can include a payment application identifier 106 and payment account data 109 for a payment account associated with the payment card that contains the EMV chip 100.

The payment application identifier 106 for a payment application 103 can be used to differentiate between different payment applications 103 stored on the EMV chip 100. The payment application identifier 106 can be used by a card reader or point of sale terminal to address individual payment applications 103 on the EMV chip 100. A payment application identifier 106 can be formed from multiple components. For example, one portion of the payment application identifier 106 could include an issuer identifier, such as a registered application provider identifier (RID) issued by the ISO/IEC 7816-5 registration authority, and an application identifier, such as a proprietary application identifier extension (PIX), which allow for application providers to differentiate among the different applications offered. For example, AMERICAN EXPRESS® has RID of A000000025. If American Express were to use a PIX of 01 for credit products (e.g., credit cards and charge cards) and a PIX of 02 for debit or electronic funds transfer (EFT) products (e.g., debit cards), then the payment application identifier 106 for an AMERICAN EXPRESS payment application 103 for credit or charge cards would be A00000002501 and the payment application identifier 106 for an AMERICAN EXPRESS payment application 103 for debit cards would be A00000002502.

The payment account data 109 can represent information associated with a payment account (e.g., bank account, credit account, etc.) that can be used to fund payments made with the payment card using the payment application 103. This can include a payment account identifier 113, an application transaction counter (ATC) 116, and a cryptogram generating key 119.

The payment account identifier 113 can represent any unique identifier that can uniquely identify a payment account with respect to another payment account. Examples of payment account identifiers 113 include bank account numbers (e.g., checking account or savings account numbers), credit card numbers, etc. Although each payment application 103 can include a separate payment account identifier 113, in some implementations the same payment account identifier 113 can be included in the payment account data 109 for two separate payment applications 103. For example, a financial institution could issue a payment card that could be used to make a payment with either a checking account (e.g., a debit card) or a line of credit (e.g., a credit card). The financial institution could issue a single or the same payment account identifier 113 for both the checking account and the line of credit so that only one payment account identifier has to be printed on the fact of the payment card.

In some instances, payment account identifiers 113 can be tokenized or virtualized, whereby one payment account identifier 113 acts as an alias for another payment account identifier 113. This can be done for a variety of reasons. For example, a payment token or virtual account identifier could be stored with a merchant for recurring payments. When the merchant requests authorization for a transaction, the payment token or virtual account identifier is submitted instead of the actual payment account identifier 113 of the account holder. If the merchant is compromised, the token or virtual account identifier is disclosed rather than the actual account identifier. As another example, a payment token or virtual account identifier can be submitted to a merchant (e.g., an electronic commerce merchant). If the checkout process is compromised, malicious third parties only know the payment token or virtual account identifier rather than the actual payment account identifier 113. The process of a payment processing system mapping a payment token or virtual account identifier to the underlying payment account identifier is often referred to as detokenizing.

In various embodiments of the present disclosure, the payment account identifier 113 could represent the actual payment account identifier 113 of an individual (e.g., his or her credit card number). In other embodiments, the payment account identifier 113 stored within a payment application 103 could be a payment token or virtual account identifier for the actual payment account identifier (e.g., a 16-digit number that acts as an alias for the actual 16-digit number that identifiers a user's credit card account). In these situations, where the payment account identifier 113 is a payment token, the payment token can simultaneously represent both a first payment account identifier 113 for a first payment account associated with a first payment processing system and a second payment account identifier 113 for a second payment account associated with a second payment processing system. For example, a single 16-digit payment token could act as an alias for both a checking account and a credit card account.

The ATC 116 can represent an integer value that can be incremented for each transaction in which a payment card or payment card instrument participates. Thet ATC 116 prevents re-use of old transactions because the issuer of the payment card or payment application 103 can reject transactions with an ATC 116 less than the highest received ATC 116.

The cryptogram generating key 119 can represent any cryptographic key that can be used for the purpose of generating a cryptogram used to authorize a transaction. One example of a cryptogram generating key 119 is an application cryptogram master key (MKAC), which is used by EMV compliant payment cards to generate a unique session key (SKAC) that can be used to create a cryptogram for each transaction. The session key (SKAC) can also be considered to be a cryptogram generating key 119 in some instances. However, other cryptographic keys could also be used as payment technologies and standards evolve.

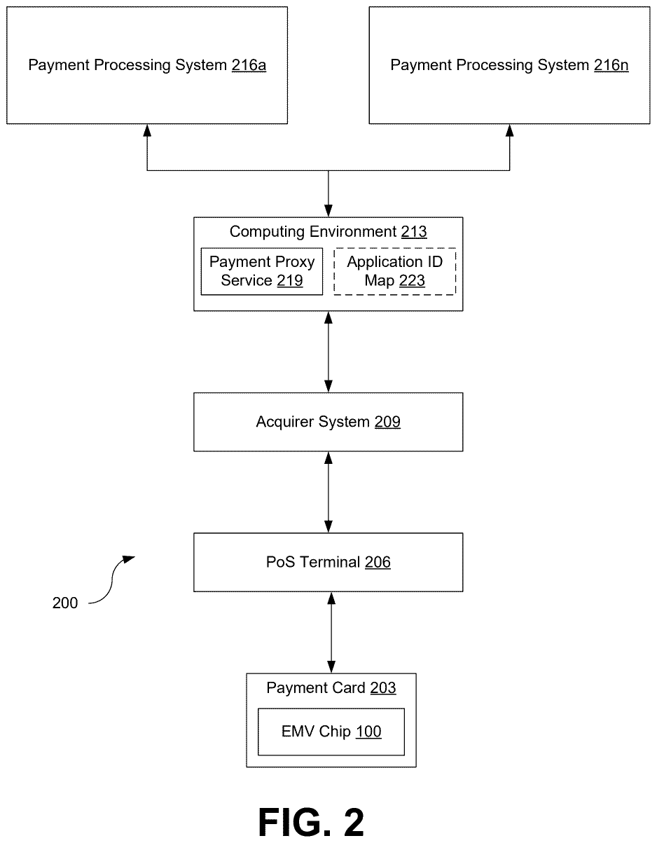

With reference to FIG. 2, shown is a payment environment 200 according to various embodiments. The payment environment 200 can represent any group or network of systems that allow for a payment to be made by a purchaser to a merchant using a payment card, such as payment card 203. Accordingly, the payment environment can also include a Point-of-Sale (PoS) terminal 206, an acquirer system 209, a computing environment 213, and one or more payment processing systems 216 (depicted as payment processing systems 216a-n).

Moreover, the individual components may be communicatively coupled or otherwise in data communication with each other as depicted. In some instances, components may be directly or physically connected to each other (e.g., as when a payment card 203 is inserted into a PoS terminal 206 to complete a transaction). In other instances, components may be connected with each other via a network, which can include wide area networks (WANs), local area networks (LANs), personal area networks (PANs), or a combination thereof. These networks can include wired or wireless components or a combination thereof. Wired networks can include Ethernet networks, cable networks, fiber optic networks, and telephone networks such as dial-up, digital subscriber line (DSL), and integrated services digital network (ISDN) networks. Wireless networks can include cellular networks, satellite networks, Institute of Electrical and Electronic Engineers (IEEE) 802.11 wireless networks (i.e., WI-FI®), BLUETOOTH® networks, microwave transmission networks, as well as other networks relying on radio broadcasts. The network can also include a combination of two or more networks. Examples of networks can include the Internet, intranets, extranets, virtual private networks (VPNs), and similar networks.

The payment card 203 can represent any smartcard usable for payments or other transactions. Accordingly, the payment card 203 can include an EMV chip 100 (FIG. 1) to initiate and/or authenticate payments made by a user. The payment card 203 can also include other mechanisms for initiating or authenticating payments, such as a magnetic stripe with account data encoded thereon.

The PoS terminal 206 can represent any physical, hosted, or virtual terminal that can interact with the payment card 203 and the EMV chip 100 thereon to generate a cryptogram and/or a transaction authorization request, which can include the cryptogram. PoS terminals 206 may be referred to as credit card machines, card readers, PIN pads, or payment terminals. Examples of PoS terminals 206 include readers that communicate with a mobile application on a mobile device (e.g., smartphone, tablet, etc.), portable PoS terminals 206 (e.g., handheld credit card machines), and dedicated or standalone PoS terminals 206 (e.g., countertop readers integrated with a cash register).

The PoS terminal 206 can be configured to perform various steps of an EMV transaction flow, such as selecting a payment application 103 for use with a transaction (including reading a list of available payment applications 103 from the EMV chip 100 and/or prompting the purchaser or card holder to select a payment application 103 from the list of available payment applications 103); reading payment application 103 data, including any payment account data 109 associated with the payment application 103; performing offline data authentication; performing cardholder verification; requesting a cryptogram from the payment application 103 (generated using the cryptogram generating key 119 and/or ATC 116); performing online transaction authorization; etc.

The acquirer system 209 can include any computer systems, applications, or software services used by the acquirer. An acquirer is a financial institution that represents the merchant in a payment transaction involving various payment rails (e.g., credit or debit card rails). The acquirer is often responsible for processing a transaction, routing it to the correct payment network and/or issuer of the payment card 200 or payment application 103, and receiving payment from the issuer on behalf of the merchant. For example, the acquirer system 209 may receive a transaction authorization request from a PoS terminal 206, determine the appropriate payment network or payment rail to route the transaction authorization request over, and forward the transaction authorization request across the payment rail to the computing environment 213 operated by the issuer of the payment card 203 or payment application 103 installed on the EMV chip 100 of the payment card 203.

As previously discussed, the computing environment 213 can be operated by the issuer of the payment card 203 or the payment application 103 installed on the EMV chip 100 of the payment card 203. The computing environment 213 can include one or more computing devices that include a processor, a memory, and/or a network interface. For example, the computing devices can be configured to perform computations on behalf of other computing devices or applications. As another example, such computing devices can host and/or provide content to other computing devices in response to requests for content.

Moreover, the computing environment 213 can employ a plurality of computing devices that can be arranged in one or more server banks or computer banks or other arrangements. Such computing devices can be located in a single installation or can be distributed among many different geographical locations. For example, the computing environment 213 can include a plurality of computing devices that together can include a hosted computing resource, a grid computing resource or any other distributed computing arrangement. In some cases, the computing environment 213 can correspond to an elastic computing resource where the allotted capacity of processing, network, storage, or other computing-related resources can vary over time.

Various applications or other functionality can be executed in the computing environment 213. The components executed on the computing environment 203 include a payment proxy service 219. The payment proxy service 219 can be executed to act as a front-end or gateway for the payment processing systems 216a-n operated by an issuer. The payment proxy service 219 can be connected to or communicate with a payment rail, such as card network (e.g., MASTERCARD®, VISA®, DISCOVER®, or AMERCIAN EXPRESS® payment networks). The payment proxy service 219 can then receive transaction authorization requests across the payment network, analyze the transaction authorization requests, and route the transaction authorization requests to the appropriate payment processing system 216.

Various types of data can also be stored by the computing environment 213 and made accessible to the applications executed by the computing environment. For example, the computing environment 213 could store an application identifier map 223. The application identifier map 223 can be used to map a payment application identifier 106 to a payment processing system 216 (e.g., a first payment application identifier 106 representing an electronic funds transfer (EFT) payment processing system 216 and a second payment application identifier 106 representing a credit card network payment processing system 216).

The payment processing systems 216a-n can be operated to process payments. Often, different payment funding sources may require different payment infrastructure to process payments. For example, debit card transactions received over a payment processing network, such as the VISA, MASTERCARD, DISCOVER, or AMERICAN EXPRESS network might need to be handled by a first payment processing system 216 configured to process payments funded by checking or savings accounts. Meanwhile, credit card transactions received over the same payment processing network might need to be handled by a second payment processing system 216 configured to process payments funded by a line of credit.

The payment proxy service 219 and the payment processing systems 216 can be operated by various entities according to various embodiments of the present disclosure. For example, in some embodiments, the payment proxy service 219 and the payment processing systems 216 could be operated by the same entity (e.g., a bank that issues payment cards 203 to allow both debit and credit card transactions using the same account number). In other embodiments, the payment proxy service 219 and the payment processing systems 216 could be operated by different entities. For example, a closed-loop payment network operator could operate the payment proxy service 219 and a first payment processing system 216, while a partner could operate a second payment processing system 216.

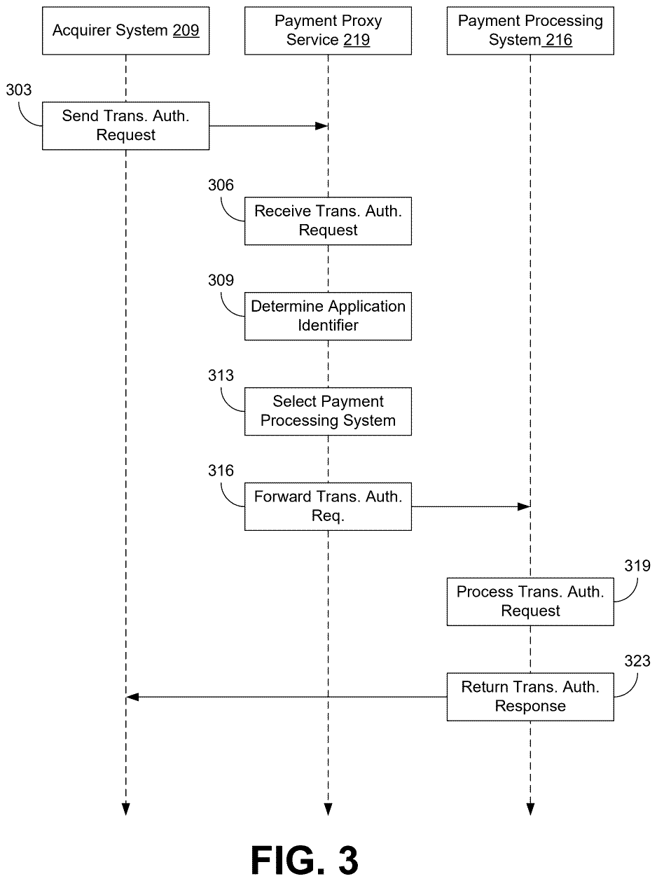

Referring next to FIG. 3, shown is a sequence diagram that provides one example of the interactions of various components of the payment environment 200, such as the acquirer system 209, the payment proxy service 219, and a payment processing system 216, to implement an embodiment of the present disclosure in the context of a card-present transaction. The sequence diagram of FIG. 3 provides merely an example of the many different types of functional arrangements that can be employed to implement the operations of the depicted portions of the acquirer system 209, payment proxy service 219, and the payment processing system 216. As an alternative, the sequence diagram of FIG. 3 can be viewed as depicting an example of elements of a method implemented within the payment environment 200.

Beginning with block 303, the acquirer system 209 can send a transaction authorization request to the payment proxy service 219. For a card-present transaction, the transaction authorization request can include a payment account identifier 113, a payment application identifier 106, a copy of the ATC 116 from the payment application 103 associated with the payment account identifier 113, and/or a cryptogram generated using the cryptogram generating key 119 associated with the payment application 103. The transaction authorization request could be received from any source that requires a payment card 203 to be present for a transaction, such as a PoS terminal 206 located at merchant or retailer (e.g., a card present transaction).

Accordingly, at block 306, the payment proxy service 219 can receive the transaction authorization request sent by the acquirer system 209 at block 303.

Next, at block 309, the payment proxy service 219 can determine the payment application identifier 106 associated with the transaction. For example, the payment proxy service 219 could parse or otherwise analyze or evaluate the transaction authorization request to determine or identity the payment application identifier 106.

Then, at block 313, the payment proxy service 219 can select the payment processing system 216 to use for authorizing and/or otherwise processing the transaction authorization request received at blocks 303 and 306. This could be done in a number of ways.

For example, the payment proxy service 219 could query the application identifier map 223 using the payment application identifier 106 determined or identified at block 309 as a search query, field, or parameter. In response, the payment proxy service 219 could determine the identity of the payment processing system 216 to use for transaction authorization requests that include the identified or determined payment application identifier 106. It should be noted that in this example, two separate accounts processed by two separate payment processing systems 216 (e.g., a bank account for debit card transactions and a line of credit for credit card transactions) could provide funding sources for the same payment account identifier 113 (e.g., the same card number). The separate accounts and separate payment processing systems 216 could be differentiated through the use of different payment application identifiers 106 stored within the separate payment applications 103 on the EMV chip 100 of the payment card 203.

As another example, the PoS terminal 206 could have obtained an indication from the purchaser whether to make the payment using an electronic funds transfer (EFT) payment (e.g., a debit card payment) or a credit payment (e.g., a credit card payment). These approaches could be used in situations where there is only a single payment application installed on the EMV chip 100 of the payment card 203. This indication could be included in the transaction authorization request as additional data or metadata. In these implementations, the payment proxy service 219 can determine the identity of the payment processing system 216 to use for transaction authorization requests that include the indicator obtained from the PoS terminal 206.

In a similar example, the payment proxy service 219 could infer the identity of the appropriate payment processing system 216 to select based on data about the transaction or transaction authorization request. For example, the payment proxy service 219 could determine the identity of the acquirer system 209 that had forwarded the transaction authorization request. The payment proxy service 219 could then select the payment processing system 216 based at least in part on the identity of the acquirer system 209.

Proceeding to block 316, the payment proxy service 219 can forward the transaction authorization request to the payment processing system 216 identified at block 313.

Subsequently, at block 319, the payment processing system 216 selected by the payment proxy service 219 at block 313 can process the transaction authorization request forwarded at block 316. In some implementations, the payment processing system 216 could detokenize the payment account identifier 113 associated with the transaction to determine the actual payment account identifier 113 for the underlying funding account. Whether or not the detokenizing step is performed, the payment processing system 216 could evaluate the ATC 116 and the cryptogram included in the transaction authorization request to determine whether or not the transaction authorization request is valid. Moreover, the payment processing system 216 could perform additional evaluations of the transaction authorization request to determine whether or not to authorize the transaction. This could include applying one or more fraud detection and/or prevention rules or one or more business rules to the transaction authorization request to determine whether to authorize the transaction.

Next, at block 323, the payment processing system 216 can return the transaction authorization response indicating whether or not the transaction has been authorized. In some instances, such as that depicted in FIG. 3, the payment processing system 216 could return the transaction authorization response directly to the acquirer system 209. In other instances, the payment processing system 216 could provide the transaction authorization response to the payment proxy service 219, which could in turn relay or return the transaction authorization response to the acquirer system 209.

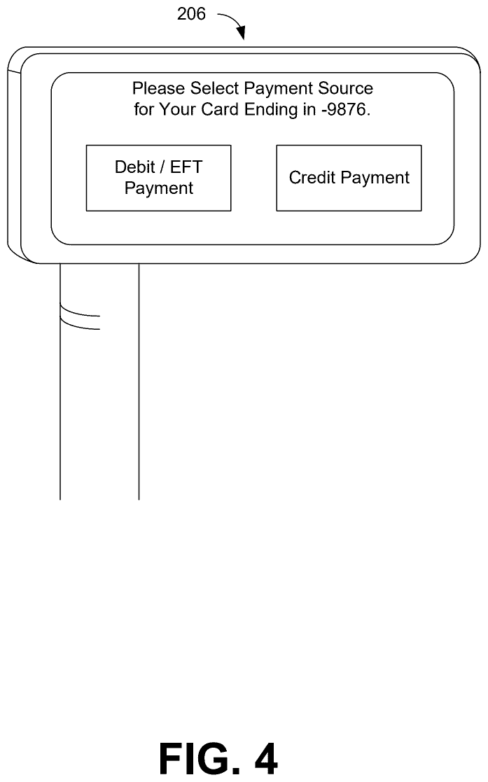

Moving on to FIG. 4, shown is an example of a PoS terminal 206 according to various embodiments of the present disclosure. In response to interacting with a payment card 200, the PoS terminal 206 could present on a screen a list of payment applications 103 associated with the payment account identifier 113 issued to the card. Here, as illustrated, the PoS terminal 206 can present the user with the option of selecting a “Debit/EFT” payment or a “Credit” payment for making a payment using the payment account identifier 113 associated with the payment card 203. If the user were to select “Debit/EFT,” then the PoS terminal 206 could include the payment application identifier 106 for the payment application 103 to be used for processing debit/EFT payments in the transaction authorization request (along with the respective ATC 116 and cryptogram generated using the respective cryptogram generating key 119). Likewise, if the user were to select “Credit,” then the PoS terminal 206 could include the payment application identifier 106 for the payment application 103 to be used for processing credit payments in the transaction authorization request (along with the respective ATC 116 and cryptogram generated using the respective cryptogram generating key 119). As shown in the example depicted in FIG. 4, a user could use a single payment card 100 associated with a single payment account identifier 113, but choose from multiple funding sources when making a payment due to the presence of multiple payment applications 103 on the EMV chip 100 of the payment card 203.

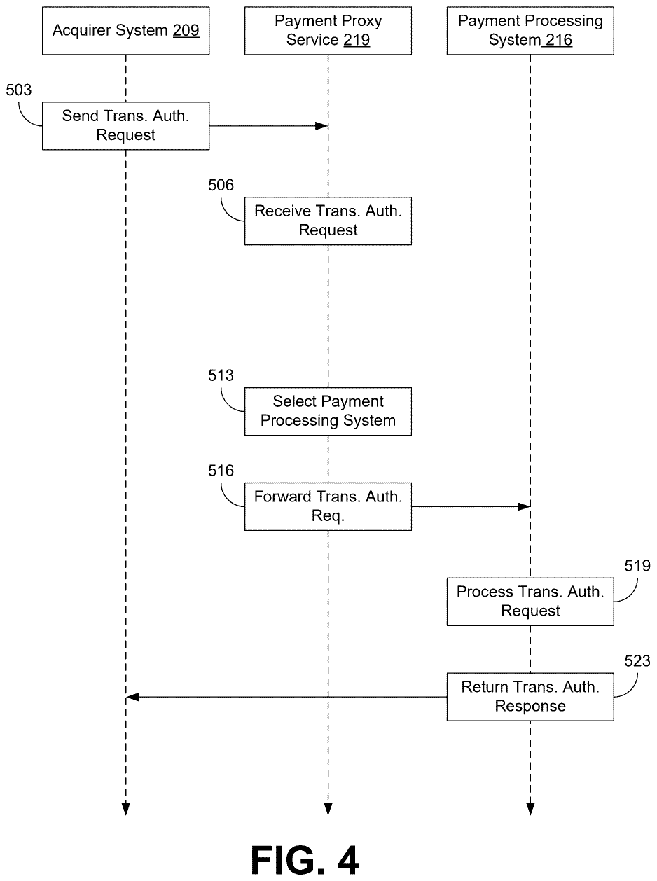

Referring next to FIG. 5, shown is a sequence diagram that provides one example of the interactions of various components of the payment environment 200, such as the acquirer system 209, the payment proxy service 219, and a payment processing system 216, to implement an embodiment of the present disclosure in the context of a card-not-present transaction. The sequence diagram of FIG. 5 provides merely an example of the many different types of functional arrangements that can be employed to implement the operations of the depicted portions of the acquirer system 209, payment proxy service 219, and the payment processing system 216. As an alternative, the sequence diagram of FIG. 5 can be viewed as depicting an example of elements of a method implemented within the payment environment 200.

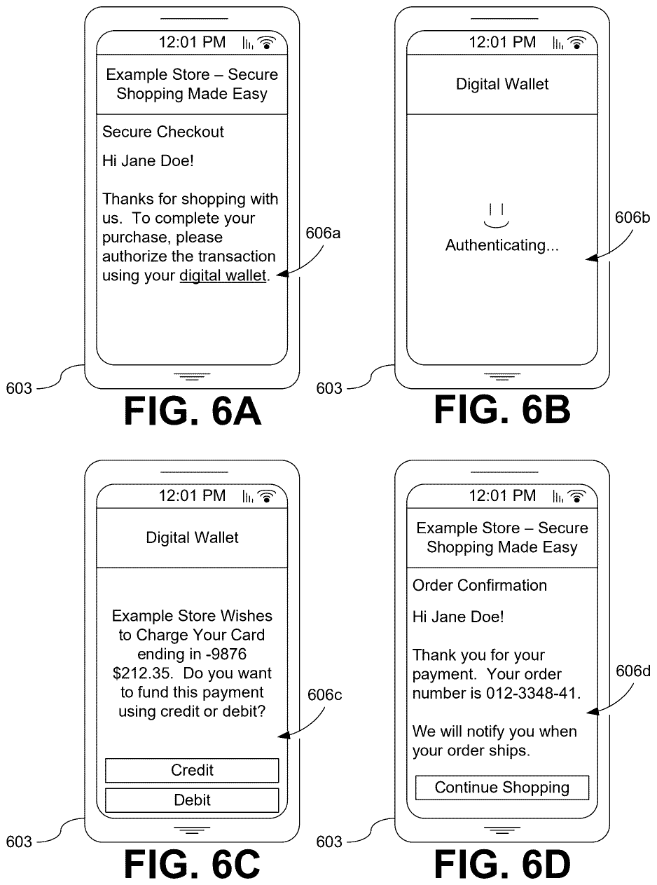

Beginning with block 503, the acquirer system 209 can send a transaction authorization request to the payment proxy service 219. For a card-not-present (CNP) transaction, the transaction authorization request could include information such as the name of the card holder, the billing address of the card holder, the expiration date of the payment card 203, the card security code (CSC) or card verification value (CVV) of the payment card 203, and potentially other data. The transaction authorization request could also include information such as an indication as to which funding account associated with a payment account identifier 113 to use for the transaction. This indicator or indication could be obtained by the merchant during the checkout process (e.g., as a question obtained during a phone order, or an indicator obtained as part of the online checkout process for an electronic commerce transaction). An example of the process through which the merchant could obtain an indicator is depicted later in FIGS. 6A-6B.

Accordingly, at block 506, the payment proxy service 219 can receive the transaction authorization request sent by the acquirer system at block 503.

Then, at block 513, the payment proxy service 219 can select the payment processing system 216 to use for authorizing and/or otherwise processing the transaction authorization request received at blocks 303 and 306. As previously discussed, a payment account number for a payment card 203 could be associated with multiple funding sources (e.g., a bank account and a line of credit), which require the use of different payment processing systems 216 to process payments. Accordingly, during a CNP transaction, the merchant could have obtained an indication as to which funding source, and therefore which payment processing system 216, should be used. For example, the merchant could have obtained an indication from the purchaser whether to make the payment using an electronic funds transfer (EFT) payment (e.g., a debit card payment) or a credit payment (e.g., a credit card payment). This indication could be included in the transaction authorization request as additional data or metadata and used to select one payment processing system 216 over another.

Proceeding to block 516, the payment proxy service 219 can forward the transaction authorization request to the payment processing system 216 identified at block 313.

Subsequently, at block 519, the payment processing system 216 selected by the payment proxy service 219 at block 513 can process the transaction authorization request forwarded at block 516. Moreover, the payment processing system 216 could perform additional evaluations of the transaction authorization request to determine whether or not to authorize the transaction. This could include applying one or more fraud detection and/or prevention rules or one or more business rules to the transaction authorization request to determine whether to authorize the transaction.

Next, at block 523, the payment processing system 216 can return the transaction authorization response indicating whether or not the transaction has been authorized. In some instances, such as that depicted in FIG. 5, the payment processing system 216 could return the transaction authorization response directly to the acquirer system 209. In other instances, the payment processing system 216 could provide the transaction authorization response to the payment proxy service

Moving on to FIGS. 6A-D, shown are a sequence of user interface diagrams depicting the user experience when prompted to confirm a transaction as a debit or credit transaction according to various embodiments of the present disclosure, such as that depicted in the sequence diagram of FIG. 5.

FIG. 6A depicts a client device 603 presenting a user interface 606a on a display of the client device 603. For example, a user could use a mobile application installed on his or her client device 603 to make a purchase from a merchant. As part of the purchase, the user could provide payment data account data 109 for his or her payment card 203, such as his or her payment account identifier 113, billing address, expiration date, security code, etc. In response, the user could be presented with the user interface 606a asking the user to complete the purchase by authorizing the transaction using his or her digital wallet application. The user interface 606a could include a link (e.g., a deeplink) that allows the user to open his or her digital wallet application on his or her client device.

FIG. 6B depicts the client device 603 authenticating the user in response to interacting with the link presented in user interface 606a to the digital wallet application. For example, the client device 603 could perform facial recognition (depicted) or other forms of authentication.

FIG. 6C depicts a client device 603 presenting a user interface 606c for the digital wallet application subsequent to authentication (e.g., as depicted in FIG. 6B). Here, the digital wallet application has received information about the transaction with the merchant. The user is presented with information about the transaction, such as a portion of his or her payment account identifier 113 used to fund the transaction and/or the amount of the transaction. The user is also presented with the option to select whether to use credit or debit as a payment rail for completing the transaction.

In response to the user selecting a payment rail, the digital wallet application can return the user to the mobile application used to make the purchase and initiated the payment, as depicted in FIG. 6D. A user interface 606d could be presented to the user, which can include information confirming the order and that payment was authorized and the transaction has been completed.

A number of software components previously discussed are stored in the memory of the respective computing devices and are executable by the processor of the respective computing devices. In this respect, the term “executable” means a program file that is in a form that can ultimately be run by the processor. Examples of executable programs can be a compiled program that can be translated into machine code in a format that can be loaded into a random-access portion of the memory and run by the processor, source code that can be expressed in proper format such as object code that is capable of being loaded into a random-access portion of the memory and executed by the processor, or source code that can be interpreted by another executable program to generate instructions in a random-access portion of the memory to be executed by the processor. An executable program can be stored in any portion or component of the memory, including random-access memory (RAM), read-only memory (ROM), hard drive, solid-state drive, Universal Serial Bus (USB) flash drive, memory card, optical disc such as compact disc (CD) or digital versatile disc (DVD), floppy disk, magnetic tape, or other memory components.

The memory includes both volatile and nonvolatile memory and data storage components. Volatile components are those that do not retain data values upon loss of power. Nonvolatile components are those that retain data upon a loss of power. Thus, the memory can include random-access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, or other memory components, or a combination of any two or more of these memory components. In addition, the RAM can include static random-access memory (SRAM), dynamic random-access memory (DRAM), or magnetic random-access memory (MRAM) and other such devices. The ROM can include a programmable read-only memory (PROM), an erasable programmable read-only memory (EPROM), an electrically erasable programmable read-only memory (EEPROM), or other like memory device.

Although the applications and systems described herein can be embodied in software or code executed by general purpose hardware as discussed above, as an alternative the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The sequence diagrams show the functionality and operation of an implementation of portions of the various embodiments of the present disclosure. If embodied in software, each block can represent a module, segment, or portion of code that includes program instructions to implement the specified logical function(s). The program instructions can be embodied in the form of source code that includes human-readable statements written in a programming language or machine code that includes numerical instructions recognizable by a suitable execution system such as a processor in a computer system. The machine code can be converted from the source code through various processes. For example, the machine code can be generated from the source code with a compiler prior to execution of the corresponding application. As another example, the machine code can be generated from the source code concurrently with execution with an interpreter. Other approaches can also be used. If embodied in hardware, each block can represent a circuit or a number of interconnected circuits to implement the specified logical function or functions.

Although the sequence diagrams show a specific order of execution, it is understood that the order of execution can differ from that which is depicted. For example, the order of execution of two or more blocks can be scrambled relative to the order shown. Also, two or more blocks shown in succession can be executed concurrently or with partial concurrence. Further, in some embodiments, one or more of the blocks shown in the sequence diagrams can be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein that includes software or code can be embodied in any non-transitory computer-readable medium for use by or in connection with an instruction execution system such as a processor in a computer system or other system. In this sense, the logic can include statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. Moreover, a collection of distributed computer-readable media located across a plurality of computing devices (e.g., storage area networks or distributed or clustered filesystems or databases) may also be collectively considered as a single non-transitory computer-readable medium.

The computer-readable medium can include any one of many physical media such as magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium can be a random-access memory (RAM) including static random-access memory (SRAM) and dynamic random-access memory (DRAM), or magnetic random-access memory (MRAM). In addition, the computer-readable medium can be a read-only memory (ROM), a programmable read-only memory (PROM), an erasable programmable read-only memory (EPROM), an electrically erasable programmable read-only memory (EEPROM), or other type of memory device.

Further, any logic or application described herein can be implemented and structured in a variety of ways. For example, one or more applications described can be implemented as modules or components of a single application. Further, one or more applications described herein can be executed in shared or separate computing devices or a combination thereof. For example, a plurality of the applications described herein can execute in the same computing device, or in multiple computing devices in the same computing environment.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X; Y; Z; X or Y; X or Z; Y or Z; X, Y, or Z; etc.). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications can be made to the above-described embodiments without departing substantially from the spirit and principles of the disclosure. All such modifications and variations are intended to be included herein within the scope of this disclosure and protected by the following claims.

Therefore, the following is claimed:

1. A system, comprising:
a computing device comprising a processor and a memory; and
machine-readable instructions stored in the memory that, when executed by the processor, cause the computing device to at least:
receive a transaction authorization request from an acquirer system, the transaction authorization request comprising a payment token, wherein the payment token simultaneously represents both a first payment account identifier for a first payment account associated with a first payment processing system and a second payment account identifier for a second payment account associated with a second payment processing system;
select the first payment processing system or the second payment processing system as a selected payment processing system based at least in part on an indicator associated with the transaction authorization request; and
forward the transaction authorization request to the selected payment processing system.

2. The system of claim 1, wherein:
the transaction authorization request is a card-present transaction authorization request that comprises a cryptogram representing the payment token and a EUROPAY®, MASTERCARD®, and VISA® (EMV) payment application identifier, wherein the EMV payment application identifier is the indicator; and
the machine-readable instructions that cause the computing device to select the first payment processing system or the second payment processing system based at least in part on the EMV payment application identifier further cause the computing device to at least:
reference an application identifier map to determine whether the first payment processing system or the second payment processing system is associated with the EMV payment application identifier.

3. The system of claim 2, wherein the machine-readable instructions that cause the computing device to select the first payment processing system or the second payment processing system based at least in part on the EMV payment application identifier further cause the computing device to at least select the first payment processing system or the second payment processing system as the selected payment processing system based at least in part on an association of the first payment processing system or the second payment processing system with the EMV payment application identifier.

4. The system of claim 1, wherein the machine-readable instructions further cause the computing device to at least receive the indicator prior to receipt of the transaction authorization request.

5. The system of claim 1, wherein the machine-readable instructions further cause the computing device to at least:
receive a transaction authorization response from the selected payment processing system; and
forward the transaction authorization response to the acquirer system.

6. The system of claim 1, wherein the first payment processing system or the second payment processing system is a debit card payment processing system, an electronic funds transfer (EFT) payment processing system, or a credit card payment processing system.

7. The system of claim 1, wherein
the machine-readable instructions further cause the computing device to at least determine an identity of the acquirer system; and
wherein the machine-readable instructions that cause the computing device to select the selected payment processing system based at least in part on the identity of the acquirer system.

8. A method, comprising:
receiving a transaction authorization request from an acquirer system, the transaction authorization request comprising a payment token, wherein the payment token simultaneously represents both a first payment account identifier for a first payment account associated with a first payment processing system and a second payment account identifier for a second payment account associated with a second payment processing system;
selecting the first payment processing system or the second payment processing system as a selected payment processing system based at least in part on an indicator included with the transaction authorization request; and
forwarding the transaction authorization request to the selected payment processing system.

9. The method of claim 8, wherein:
the transaction authorization request is a card-present transaction authorization request that comprises a cryptogram representing the payment token and a EUROPAY®, MASTERCARD®, and VISA® (EMV) payment application identifier, wherein the EMV payment application identifier is the indicator; and
wherein selecting the first payment processing system or the second payment processing system based at least in part on the EMV payment application identifier further comprises:
referencing an application identifier map to determine whether the first payment processing system or the second payment processing system is associated with the EMV payment application identifier.

10. The method of claim 8, wherein selecting the first payment processing system or the second payment processing system based at least in part on the EMV payment application identifier further cause the computing device to at least select the first payment processing system or the second payment processing system as the selected payment processing system based at least in part on an association of the first payment processing system or the second payment processing system with the EMV payment application identifier.

11. The method of claim 8, further comprising receiving the indicator prior to receipt of the transaction authorization request.

12. The method of claim 8, further comprising:
receiving a transaction authorization response from the selected payment processing system; and
forwarding the transaction authorization response to the acquirer system.

13. The method of claim 8, wherein the first payment processing system or the second payment processing system is a debit card payment processing system, an electronic funds transfer (EFT) payment processing system, or a credit card payment processing system.

14. The method of claim 8, wherein
the method further comprises determining an identity of the acquirer system; and
wherein selecting the selected payment processing system is based at least in part on the identity of the acquirer system.

15. A non-transitory, computer-readable medium, comprising machine-readable instructions that, when executed by a processor of a computing device, cause the computing device to at least:
receive a transaction authorization request from an acquirer system, the transaction authorization request comprising a payment token, wherein the payment token simultaneously represents both a first payment account identifier for a first payment account associated with a first payment processing system and a second payment account identifier for a second payment account associated with a second payment processing system;
select the first payment processing system or the second payment processing system as a selected payment processing system based at least in part on an indicator included with the transaction authorization request; and
forward the transaction authorization request to the selected payment processing system.

16. The non-transitory, computer-readable medium of claim 15, wherein:
the transaction authorization request is a card-present transaction authorization request that comprises a cryptogram representing the payment token and a EUROPAY®, MASTERCARD®, and VISA® (EMV) payment application identifier, wherein the EMV payment application identifier is the indicator; and
the machine-readable instructions that cause the computing device to select the first payment processing system or the second payment processing system based at least in part on the EMV payment application identifier further cause the computing device to at least:
reference an application identifier map to determine whether the first payment processing system or the second payment processing system is associated with the EMV payment application identifier.

17. The non-transitory, computer-readable medium of claim 16, wherein the machine-readable instructions that cause the computing device to select the first payment processing system or the second payment processing system based at least in part on the EMV payment application identifier further cause the computing device to at least select the first payment processing system or the second payment processing system as the selected payment processing system based at least in part on an association of the first payment processing system or the second payment processing system with the EMV payment application identifier.

18. The non-transitory, computer-readable medium of claim 15, wherein the machine-readable instructions further cause the computing device to at least receive the indicator prior to receipt of the transaction authorization request.

19. The non-transitory, computer-readable medium of claim 15, wherein the machine-readable instructions further cause the computing device to at least:
receive a transaction authorization response from the selected payment processing system; and
forward the transaction authorization response to the acquirer system.

20. The non-transitory, computer-readable medium of claim 15, wherein the first payment processing system or the second payment processing system is a debit card, electronic funds transfer (EFT) payment processing system, or a credit card payment processing system.
